(19) United States
(12) Patent Application Publication
(10) Pub. No.: US 2019/0289396 A1
(43) Pub. Date: Sep. 19, 2019

(54) ELECTRONIC DEVICE FOR SPATIAL OUTPUT

(71) Applicant: Microsoft Technology Licensing, LLC, Redmond, WA (US)

(72) Inventors: Kendall Clark YORK, Bellevue, WA (US); John B. HESKETH, Kirkland, WA (US); Janet SCHNEIDER, Bellevue, WA (US); Jeffrey SIPKO, Kirkland, WA (US)

(21) Appl. No.: 15/922,448

(22) Filed: Mar. 15, 2018

(51) Int. Cl. H04R 5/02; H01Q 1/27; H04B 1/3827; H04R 3/00; H04R 3/12; H04R 1/32; H04R 1/40; H04S 7/00; G06F 1/16; G06F 3/16; G10L 15/22

(52) U.S. Cl. CPC H04R 5/02; G10L 2015/223; H04B 1/385; H04R 3/005; H04R 3/12; H04R 1/323; H04R 1/403; H04S 7/303; H04S 7/308; G06F 1/163; G06F 3/165; G06F 3/167; G10L 15/22; H04R 2420/07; H04S 2400/01; H01Q 1/273

(57) ABSTRACT

The disclosed technology provides a spatial output device comprised of two electronics enclosures that are electrically connected by a flexible electronic connector. The two electronics enclosures are weighted to maintain a balanced position of the flexible connector against a support. The spatial output device has at least one input sensor affixed to one of the two electronics enclosures and an onboard processor affixed to one of the two electronics enclosures. The input sensor is configured to receive monocular input. The onboard processor is configured to process the monocular input to generate a spatial output, where the spatial output provides at least two-dimensional information.

### CROSS-REFERENCE TO RELATED APPLICATIONS

The present application is related to U.S. patent application Ser. No. ______ [Docket No. 404005-US-NP], entitled “Remote Multi-Dimensional Audio,” which is filed concurrently herewith and is specifically incorporated by reference for all that it discloses and teaches.

### BACKGROUND

Continually gather large amounts of data to understand a user's environment via a variety of sensors can enhance mixed reality experiences and/or improve the accuracy of directions or spatial information within an environment. Current wearable devices may have limited functionality. Some wearable devices may be limited to basic audio and video capture, without the ability to process the information on the device. Other wearable devices may require stereo input to produce spatial information about the user's environment, which may make the devices prohibitively expensive.

### SUMMARY

In at least one implementation, the disclosed technology provides a spatial output device comprised of two electronics enclosures that are electrically connected by a flexible electronic connector. The two electronics enclosures are weighted to maintain a balanced position of the flexible connector against a support. The spatial output device has at least one input sensor affixed to one of the two electronics enclosures and an onboard processor affixed to one of the two electronics enclosures. The input sensor is configured to receive monocular input. The onboard processor is configured to process the monocular input to generate a spatial output, where the spatial output provides at least two-dimensional information.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIGS. 1A, 1B, and 1C illustrate an example spatial output device.

FIG. 2 illustrates a schematic of an example spatial output device.

FIG. 3 illustrates example operations for a spatial output device.

### DETAILED DESCRIPTIONS

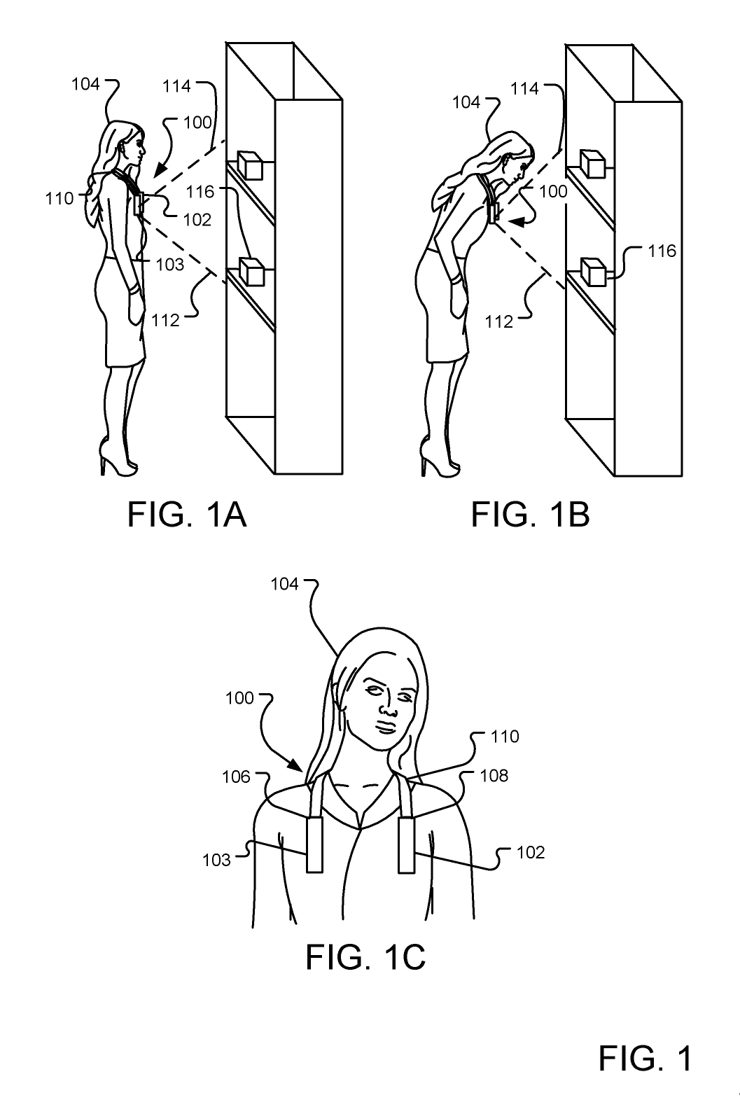

FIGS. 1A, 1B, and 1C illustrate an example spatial output device 100. FIG. 1A depicts the spatial output device 100 in use by a user 104. The spatial output device 100 includes a right electronic enclosure 103 and a left electronic enclosure 102 connected by a flexible connector 110. In at least one implementation, the right electronic enclosure 103 and the left electronic enclosure 102 are of substantially equal weight so that the spatial output device 100 remains balanced around the neck of the user 104, particularly when the flexible connector 110 slides easily on a user's neck or collar. The flexible connector 110 may include connective wires to provide a communicative connection between the right electronic enclosure 103 and the left electronic enclosure 102. The flexible connector 110 can be draped across a user's neck, allowing the extreme ends of the right electronic enclosure 103 and the left electronic enclosure 102 to hang down from the user's neck against the user's chest. Because the spatial output device 100 may lie flat against the user's chest on one user but not another user, depending on the contour or shape of the user's chest, a camera in the spatial output device 100 may be adjustable manually or automatically to compensate for the altered field of view caused by different chest shapes and/or sizes.

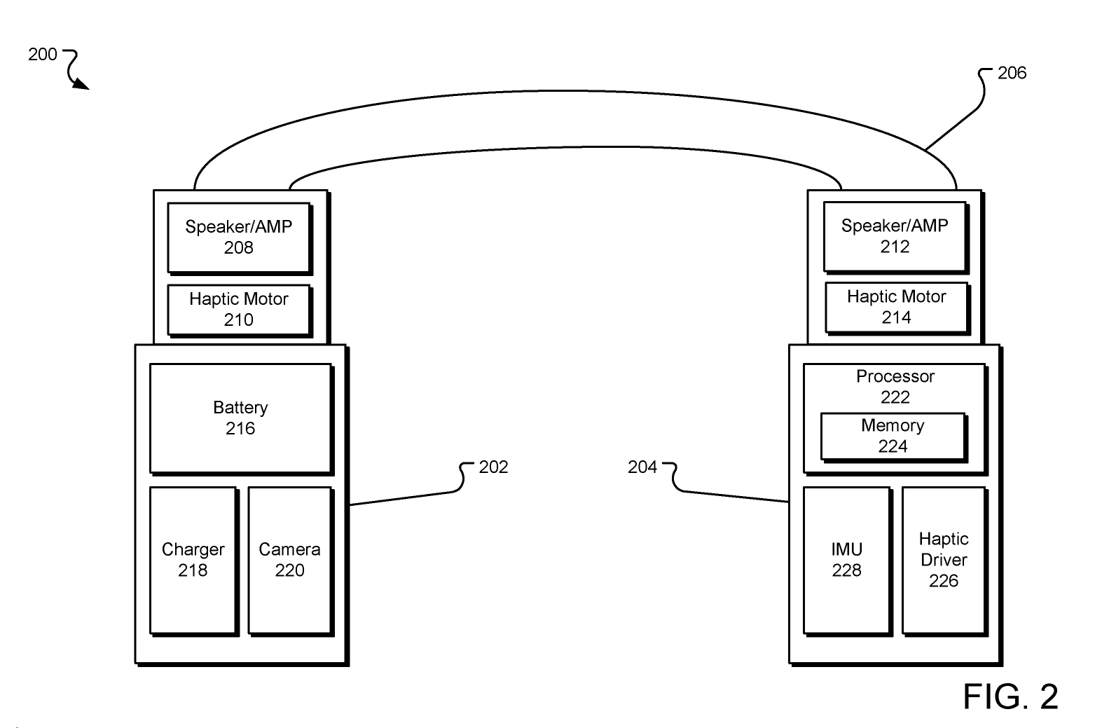

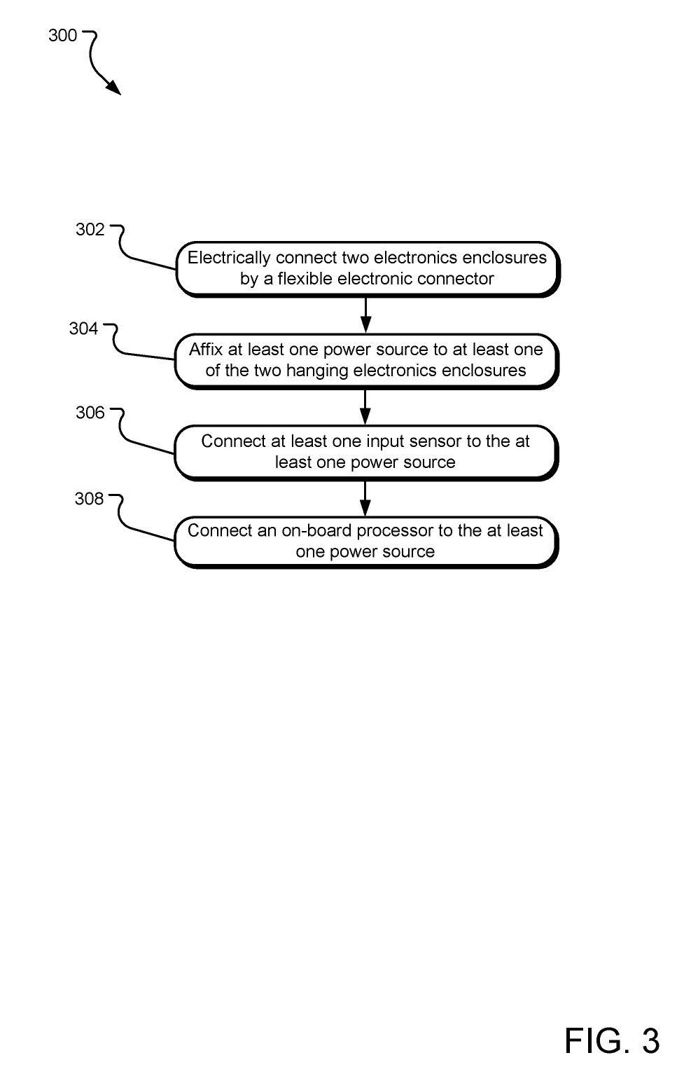

A camera on the spatial output device 100 has a field of view indicated by broken lines 112 and 114. The camera on the spatial output device 100 continuously captures data about objects within its field of view. For example, in FIG. 1A, when the user 104 is standing in front of a shelf, the camera on the spatial output device 100 captures a first object 116 and a second object sitting on the shelf. The camera on the spatial output device 100 transmits its field of view to an onboard processor on the spatial output device. As discussed in more detail below with reference to FIGS. 2 and 3, the onboard processor processes the input from the camera to generate spatial output.

The onboard processor continuously receives data from the camera and processes that data to generate spatial output. The spatial output is contributed to a map that is developed over time by the spatial output generated by the onboard processor. The onboard processor integrates spatial output with an existing map or other spatial output data to develop the map over time. The map may include information about a particular space (i.e., a room, warehouse, or building), such as the location of walls, doors, and other physical features in the space, objects in the space, and the location of the spatial output device 100 within the space. Similarly, the spatial output used to develop the map may include data about the location of physical features in a space, objects in the space, or the location of the spatial output device 100 relative to physical features or objects in the space. In some implementations, the map is stored on the spatial output device 100 for easy reference by the spatial output device 100. In another implementation, the map is uploaded from the spatial output device 100 to a remote computing location through a wireless (e.g., Wi-Fi) or wired connection on the spatial output device 100. The remote computing location may be, for example, the cloud or an external server.

When the map is uploaded to a remote computing location, the map may be shared between the spatial output device 100 and other spatial output devices (not shown) to generate a shared map. The shared map may further include information about the location of each of the spatial output devices relative to each other. Knowing the relative location of the spatial output device can enable communication between the spatial output devices, such as by providing remote multi-dimensional audio.

In some implementations, the user 104 may be able to access the map to receive directions to a particular object or location within the map. For example, the user 104 may leave the position shown in FIG. 1A and move to another area of the room. The user 104 may wish to navigate back to the first object 116 but may not remember where the first object 116 is located. The user 104 may give some input to the spatial audio device 100 to indicate that the user 104 wants to be guided to the first object 116. The input may be, for example, without limitation, scanning a barcode of the first object 116 with the camera of the spatial audio device 100 or reciting an identifier associated with the first object 116 to a microphone in the spatial audio device 100. The spatial output device 100 may then access the map to prepare directions to direct the user 104 to the first object 116. Here, the location of the first object 116 is part of the map because the camera on the spatial output device 100 captured the first object 116 when the user 104 was standing in front of the first object 116.

The spatial output device 100 may guide the user 104 through a pair of spatial output mechanisms, where one spatial output mechanism is affixed to the left electronic enclosure 102, and another spatial output mechanism is affixed to the right electronic enclosure 103. The pair of spatial output mechanisms may be, for example, a pair of open-air speakers or a pair of haptic motors. The pair of spatial output mechanisms may convey directions to the user by, for example, vibrating or beeping to indicate what direction the user should turn. For example, if the spatial output mechanisms are a pair of haptic motors, the haptic motor affixed to the left electronic enclosure 102 may vibrate when the user 104 should turn left and the haptic motor affixed to the right electronic enclosure 103 may vibrate when the user 104 should turn right. Other combinations of vibrations or sounds may direct the user to a particular location. In some implementations, such as when headphones are used, the spatial output mechanisms may not be affixed to the left electronic enclosure 102 and the right electronic enclosure 103. For example, when headphones are used for spatial output, the headphones may be connected via an audio jack in the spatial output device 100 or through a wireless connection.

FIG. 1B depicts the spatial output device 100 around the neck of the user 104 when the user 104 is bent over. The spatial output device 100 remains balanced when the user 104 bends over or moves in other directions because the right electronic enclosure 103 and the left electronic enclosure 102 are of substantially the same weight. When the user 104 bends over, as the spatial output device 100 continues to hang at substantially the same angle relative to the ground, so that the field of view of the camera remains the substantially the same whether the user 104 is standing straight or bending over, as indicated by the broken lines 112 and 114. In one implementation, the fields of view between standing and bending over are identical, although other implementations provide a substantial overlap in the field of views of the two states: standing and bending over. Use of a wide-angle lens or a fish-eye lens may also facilitate an overlap in the field of views.

The flexible connector 110 allows the spatial output device 100 to hang relative to the ground instead of being in one fixed orientation relative to the chest of the user 104. For example, if the user 104 were bent over closer to the ground, the left electronic enclosure 102 and the right electronic enclosure 103 would still be oriented roughly perpendicular to the ground. Accordingly, a camera affixed to either the left electronic enclosure 102 or the right electronic enclosure 103 has a consistent angle of view whether the user 104 is standing straight up or is bent over.

FIG. 1C depicts the spatial output device 100, that may act as both an audio transmitting device and an audio outputting device. The spatial output device 100 has at least one audio input and at least two audio outputs 106 and 108. In one implementation, the audio outputs 106 and 108 are open speakers. In other implementations, the audio outputs 106 and 108 may be headphones, earbuds, headsets, or any other listening device. In at least one implementation, the spatial output device 100 also includes a processor, at least one camera, and at least one inertial measurement unit (IMU). In some implementations, the audio device 100 may also include other sensors, such as touch sensors, pressure sensors, or altitude sensors. Additionally, the spatial output device 100 may include inputs, such as haptic sensors, proximity sensors, buttons, or switches. The spatial output device 100 may also include additional outputs, for example, without limitation, a display or haptic feedback motors. Though the spatial output device 100 is shown in FIG. 1 being worn around the neck of a user 104, the spatial output device 100 may take other forms and may be worn on other parts of the body of the user 104. As shown in FIG. 1C, the speakers 106 and 108 are located on the spatial output device 100 so that the speaker 106 generally corresponds to one ear of the user 104 and the speaker 108 generally corresponds to the other ear of the user 104. The placement of the audio outputs 106 and 108 allows for the spatial audio output. Additional audio outputs may also be employed (e.g., another speaker hanging at the user's back).

The left electronic enclosure 102 and the right electronic enclosure 103 are weighted to maintain a balanced position of the flexible electronic connector 110. The flexible electronic connector 110 is in a balanced position when it remains in place on the user 104 and is not sliding to the right or the left of the user 104 based on the weight of the left electronic enclosure 102 or the right electronic enclosure 103. To maintain the balanced position of the flexible electronic connector 110, the left electronic enclosure 102 and the right electronic enclosure 103 are substantially the same weight. The left electronic enclosure 102 may have components that are the same weight as components in the right electronic enclosure 103. In other implementations, weights or weighted materials may be used so that the left electronic enclosure 102 and the right electronic enclosure 103 are substantially the same weight.

In some implementations, the flexible electronic connector 110 may include an adjustable section. The adjustable section may allow the user 104 to adjust the length of the flexible electronic connector for the comfort of the user 104 or to better align the left electronic enclosure 102 and the right electronic enclosure 103 based on the height and build of the user 104. The flexible electronic connector 110 may also include additional sensors, such as heart rate or other biofeedback sensors, to obtain data about the user 104.

In some implementations, the spatial output device 100 may also be a spatial input device. For example, the spatial output device 100 may also receive spatial audio through a microphone located on the left electronic enclosure 102 or the right electronic enclosure 103.

FIG. 2 illustrates a schematic of an example spatial output device 200. The spatial output device 200 includes a left electronic enclosure 202 and a right electronic enclosure 204 connected by a flexible connector 206. In the illustrated implementation, the flexible connector 206 includes wiring or other connections to provide power and to communicatively connect the left electronic enclosure 202 with the right electronic enclosure 204, although other implementations may employ wireless communications, a combination of wireless and wired communication, distributed power sources, and other variations in architecture. The left electronic enclosure 202 and the right electronic enclosure 204 are substantially weight-balanced to prevent the spatial output device 200 from sliding off a user's neck unexpectedly. In some implementations, the electronic components and the left electronic enclosure 202 weigh substantially the same as the electronic components and the right electronic enclosure 204. In other implementations, any type of weight may be added or re-distributed to either the left electronic enclosure 202 or the right electronic enclosure 204 to balance the weights of the left electronic enclosure 202 and the right electronic enclosure 204.

In the spatial output device 200 of FIG. 2, the left electronic enclosure 202 includes a speaker 208 and a haptic motor 210. The right electronic enclosure 204 also includes a speaker 212 and a haptic motor 214. The speaker 208 may be calibrated to deliver audio to the left ear of a user while the speaker 212 may be calibrated to deliver audio to the right ear of a user. In some implementations, the speaker 208 and the speaker 212 may be replaced with earbuds or other types of headphones to provide the audio output for the spatial output device 200. The haptic motor 210 and the haptic motor 214 provide spatial haptic output to the user of the spatial output device 200. A haptic driver 226 in the right electronic enclosure 204 controls the haptic motor 210 and the haptic motor 214.

The left enclosure 202 further includes a battery 216, a charger 218, and a camera 220. The charger 218 charges the battery 216 and may have a charging input or may charge the battery through proximity charging. The battery 216 may be any type of battery suitable to power the spatial output device 200. The battery 216 powers electronics in both the left enclosure 202 and the right enclosure 204 through electrical connections that are part of the flexible connector 206.

The camera 220 provides a wide field of view through use of a wide angle or fish-eye lens, although other lenses may be employed. The camera 220 is a monocular camera. The camera 220 is angled to provide a wide field of view. The angle of the camera 220 may change depending on the anatomy of the user of the spatial output device 200. For example, the camera 220 may be at one angle for a user with a fairly flat chest and at a different angle for a user with a fuller chest. In some implementations, the user may adjust the camera 220 manually to achieve a good angle for a wide field of view. In other implementations, the spatial output device 200 may automatically adjust the camera 220 when a new user uses the spatial output device 200. For example, in one implementation, the spatial output device 200 may sense the angle of a new user's chest and adjust the angle of the camera 220 accordingly. In another implementation, the spatial output device may be able to recognize different users through, for example, a fingerprint sensor or an identifying sensor, where each user pre-sets an associated angle of the camera 220.

The right enclosure 204 further includes a processor 222 with memory 224 and an IMU 226. The processor 222 provides onboard processing for the spatial output device 200. The processor 222 may include a connection to a communication network (e.g., a cellular network or WI-FI network). The memory 224 on the processor 222 may store information relating to the spatial output device 200, including, without limitation, a shared map of a physical space, user settings, and user data. The processor 222 may additionally perform calculations to provide spatialized output to the user of the spatial output device 200. The IMU 228 provides information about the movement of the spatial output device 200 in each dimension.

The processor 222 receives data from the camera 220 of the spatial output device. The processor 222 processes the data received from the camera 220 to generate spatial output. In some implementations, the information provided by the IMU may assist the spatial output device 200 in processing input from the monocular camera 220 to obtain spatial output. For example, in one implementation, the spatial output may be calculated by the processor using simultaneous location and mapping (SLAM) where the IMU provides the processor with data about the acceleration and the orientation of the camera 220 on the spatial output device 200.

The processor 222 may continuously receive data from the camera 220 and continuously process the data received from the camera 220 to generate spatial output. The spatial output may provide information about a particular space (i.e., a room, warehouse, or building), such as the location of walls, doors, and other physical features in the space, objects in the space, and the location of the spatial output device 200 within the space. The continual spatial output may be used by the processor 222 to generate a map of a physical space. The map may include data about the location of physical features in a space, objects in the space, or the location of the spatial output device 200 relative to physical features or objects in the space. The map may be used by the processor 222 to, for example, guide a user to a particular location in the space using the haptic motor 210 and the haptic motor 214.

In some implementations, the map is stored on the memory 224 of the processor 222 for easy reference by the spatial output device 200. In another implementation, the map is uploaded from the spatial output device 200 to a remote computing location through a wireless (e.g., WIFI) or wired connection on the spatial output device 200. The remote computing location may be, for example, the cloud or an external server. When the map is uploaded to a remote computing location, it may be combined with other maps of other spatial output devices operating in the same space to create a more detailed shared map of the space. The shared map may be accessible by all the spatial output devices operating in a space. The shared map may be used by multiple spatial output devices to enable communication between multiple spatial output devices, such as by providing remote multi-dimensional audio.

The spatial output device 200 may guide a user to a particular location on the map using pairs of spatial output mechanisms. The spatial output mechanisms may be, for example, the speaker 208 and the speaker 212 or the haptic motor 210 and the haptic motor 214. In an example implementation, a user is guided to a location on the map using the speaker 208 and the speaker 212. The speaker 208 may emit a tone when the directions indicate that the user should turn right. Similarly, the speaker 212 may emit a tone when the directions indicate that the user should turn left. The speaker 208 and the speaker 212 may emit other tones signaling other information to the user. For example, the speaker 208 and the speaker 212 may emit a combined tone when the user reaches the location.

In some implementations, the spatial output device 200 may include sensors to allow the spatial output device 200 to distinguish between users. For example, the spatial output device 200 may include a fingerprint sensor. The spatial output device 200 may maintain multiple user profiles associated with the fingerprints of multiple users. When a new user wishes to log in to the spatial output device 200, the new user may do so by providing a fingerprint. Other sensors may be used for the same purpose, such as, without limitation a camera for facial recognition or a microphone that has the ability to distinguish between the voices of multiple users.

The spatial output device 200 may include additional electronic components in either the left electronic enclosure 202 or the right electronic enclosure 204. For example, the spatial output device 200 may include, without limitation, biometric sensors, beacons for communication with external sensors placed in a physical space, and user input components, such as buttons, switches, or touch sensors.

FIG. 3 illustrates example operations for a spatial output device. In a connecting operation 302, two electronics enclosures are electrically connected by a flexible electronic connector. When in use, the flexible electronic slidably hangs from a support, meaning that the flexible electronic connector is capable of sliding on the support.

An affixing operation 304 affixes at least one power source to at least one of the two hanging electronics enclosures. In one implementation, the power source is located in one of the two electronics enclosures and is connected to the other electronics enclosure via the flexible electronic connector.

A connecting operation 306 connects at least one input sensor to the power source. The input sensor is affixed to one of the two hanging electronics enclosures and receives a monocular input. In one implementation, the input sensor is a monocular camera.

A second connecting operation 308 connects an onboard processor to the at least one power source. The onboard processor processes the monocular input to generate a spatialized output. In some implementations, the monocular input may be processed along with information from other sensors on the spatial output device, such as IMUs, to generate a spatialized output. For example, in one implementation, the spatial output may be calculated by the processor using simultaneous location and mapping (SLAM) where the IMU provides the processor with data about the acceleration of the camera on the spatial output device. The acceleration data provided by the IMU can be used to calculate the distance the camera travels between two images of the same reference point.

In one implementation, the monocular input is processed to generate a spatialized output by building graphs for sensors on the spatial output device. A sensor graph is built for each sensor of the spatial output device that will be used to provide data. Nodes are added to the graph each time a sensor reports that it has substantially new data. Edges created between the newly added node and the previous node represent the spatial transformation between the nodes, as well as the intrinsic error reported by the sensor. A meta-graph is also built, and a new node is also added to the meta-graph when a new node is added to the sensor graph. When the new node is added to the meta-graph, it is called a spatial print. When a spatial print is created, each sensor graph is queried, and edges are created from the spatial print to the most current node of each sensor graph with data available. Accordingly, the meta-graph contains a trail of nodes representing a history of measured locations. As new data is added to the meta-graph, the error value of each edge is analyzed, and the estimated position of each of the previous nodes is adjusted to minimize total error. Any type of sensor may act as an input to the system, including, without limitation, fiducial tag tracking with a camera, object or feature recognition with a camera, GPS, Wi-Fi fingerprinting, and sound source localization.

The onboard processor also outputs the spatial output. In some implementations, the spatial output may be output to memory on the processor of the spatial output device. In other implementations, the spatial output may be output to a remote computing location (e.g., the cloud or an external server) via a communicative connection between the spatial output device and the remote computing location (e.g., WIFI, cellular network, or other wireless connection).

In some implementations, one or more tangible processor-readable storage media are embodied with instructions for executing on one or more processors and circuits of a computing device a process including processing the monocular input to generate a spatial output or outputting the spatial output. The one or more tangible processor-readable storage media may be part of a computing device.

The computing device may include a variety of tangible processor-readable storage media and intangible processor-readable communication signals. Tangible processor-readable storage can be embodied by any available media that can be accessed by the computing device and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the computing device. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

An example spatial output device is provided. The spatial output device includes a flexible electronics connector configured to slidably hang from a support and two electronics enclosures electrically connected by the flexible electronic connector. Each electronics enclosure is weighted relative to the other electronics enclosure to maintain a balanced position hanging from the flexible electronic connector. The spatial output device further includes at least one power source affixed to at least one of the two hanging electronics enclosures and at least one input sensor affixed to at least one of the two hanging electronics enclosures and powered by the at least one power source, the at least one input sensor being configured to receive a monocular input. The spatial output device further includes one or more onboard processors affixed to at least one of the two hanging electronics enclosures and powered by the at least one power source, the onboard processor configured to process the monocular input received from the at least one input sensor to generate a spatial output providing at least two-dimensional information.

A spatial output device of any previous spatial output device is provided, where the one or more onboard processors is further configured to transmit the spatial output to a remote computing location.

A spatial output device of any previous spatial output device is provided, where the support from which the flexible connector hangs includes a neck of the user and the at least one input sensor includes at least one biometric input sensor, the at least one biometric input sensor being configured to determine the identity of the user of the spatial output device.

A spatial output device of any previous spatial output device further includes one or more processor-readable storage media devices, where the one or more onboard processors is further configured to integrate the spatial output into a digital map representation stored in the one or more processor-readable storage media devices.

A spatial output device of any previous spatial output device is provided, where the one or more onboard processors is further configured to output directional information directed to a location on the digital map representation through one or more spatial output components.

A spatial output device of any previous spatial output device is provided, where the one or more spatial output components includes one of a speaker or headphones.

A spatial output device of any previous spatial output device is provided, where the one or more spatial output components include a haptic motor.

A spatial output device of any previous spatial output device is provided, where the at least one input sensor includes an internal measurement unit (IMU), the IMU configured to provide acceleration data and orientation data to the one or more onboard processors.

A spatial output device of any previous spatial output device is provided, where the one or more onboard processors is further configured to process the monocular input to generate the spatial output using the acceleration data and the orientation data provided by the IMU.

An example spatial sensing and processing method includes electrically connecting two electronics enclosures by a flexible electronic connector, the two electronic enclosures hanging from the flexible electronic connector, the flexible electronic being configured to slidably hang from a support, each of the two electronics enclosures being weighted relative to the other electronics enclosure to maintain a balanced position hanging from the flexible electronic connector and the support. The method further includes affixing at least one power source to at least one of the two hanging electronics enclosures and connecting at least one input sensor to the at least one power source, the at least one input sensor being affixed to at least one of the two hanging electronics enclosures to receive a monocular input. The method further includes connecting an onboard processor to the at least one power source, the onboard processor being affixed to at least one of the two hanging electronics enclosures, the onboard processor being configured to process the monocular input received from the at least one input sensor to generate a spatial output providing at least two-dimensional information.

An example method of any previous method is provided, where the spatial output is output to a remote computing location.

An example method of any previous method is provided, where the onboard processor is further configured to integrate the spatial output with a map.

An example method of any previous method is provided, where the onboard processor is further configured to provide directions to a location on the map through a pair of spatial output mechanisms located on each of the two electronics enclosures.

An example method of any previous method is provided, where the pair of spatial output mechanisms are one of speakers or headphones.

An example method of any previous method is provided, where the pair of spatial output mechanisms are haptic motors.

An example method of any previous method further includes connecting an internal measurement unit (IMU) to the at least one power source, the IMU being configured to provide acceleration data and orientation data to the onboard processor.

An example method of any previous method is provided, where the onboard processor is further configured to process the monocular input to generate the spatial output using the acceleration data and the orientation data provided by the IMU.

An example system includes means for electrically connecting two electronics enclosures by a flexible electronic connector, the two electronic enclosures hanging from the flexible electronic connector, the flexible electronic being configured to slidably hang from a support, each of the two electronics enclosures being weighted relative to the other electronics enclosure to maintain a balanced position hanging from the flexible electronic connector and the support. The system further includes means for affixing at least one power source to at least one of the two hanging electronics enclosures and means for connecting at least one input sensor to the at least one power source, the at least one input sensor being affixed to at least one of the two hanging electronics enclosures to receive a monocular input. The system further includes means for connecting an onboard processor to the at least one power source, the onboard processor being affixed to at least one of the two hanging electronics enclosures, the onboard processor being configured to process the monocular input received from the at least one input sensor to generate a spatial output providing at least two-dimensional information.

An example system of any preceding system is provided, where the spatial output is output to a remote computing location.

An example system of any preceding system is provided, where the onboard processor is further configured to integrate the spatial output with a map.

An example system of any preceding system is provided, where the onboard processor is further configured to provide directions to a location on the map through a pair of spatial output mechanisms located on each of the two electronics enclosures.

An example system of any preceding system is provided, where the pair of spatial output mechanisms are one of speakers or headphones.

An example system of any preceding system is provided, where the pair of spatial output mechanisms are haptic motors.

An example system of any preceding system further includes means for connecting an internal measurement unit (IMU) to the at least one power source, the IMU being configured to provide acceleration data and orientation data to the onboard processor.

An example system of any preceding system is provided, where the onboard processor is further configured to process the monocular input to generate the spatial output using the acceleration data and the orientation data provided by the IMU.

An example spatial output device includes a flexible electronics connector configured to slidably hang from a support and two electronics enclosures electrically connected by the flexible electronic connector, each electronics enclosure being weighted relative to the other electronics enclosure to maintain a balanced position hanging from the flexible electronic connector. The spatial output device further includes at least one power source affixed to at least one of the two hanging electronics enclosures and at least one input sensor affixed to at least one of the two hanging electronics enclosures and powered by the at least one power source, the at least one input sensor being configured to receive a monocular input.

A spatial output device of any previous spatial output device further includes one or more onboard processors affixed to at least one of the two hanging electronics enclosures and powered by the at least one power source, the onboard processor configured to process the monocular input received from the at least one input sensor to generate a spatial output providing at least two-dimensional information.

A spatial output device of any previous spatial output device further includes one or more processor-readable storage media devices, wherein the one or more onboard processors is further configured to integrate the spatial output into a digital map representation stored in the one or more processor-readable storage media devices.

Some implementations may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

1. A spatial output device comprising:
a flexible electronics connector configured to slidably hang from a support;
two hanging electronics enclosures electrically connected by the flexible electronic connector, each electronics enclosure being weighted relative to the other electronics enclosure to maintain a balanced position hanging from the flexible electronic connector;
at least one power source affixed to at least one of the two hanging electronics enclosures;
a single monocular camera affixed to at least one of the two hanging electronics enclosures and powered by the at least one power source, the single monocular camera being configured to produce a monocular output of physical features in a physical environment of the spatial output device; and
one or more onboard processors affixed to at least one of the two hanging electronics enclosures and powered by the at least one power source, the one or more onboard processors being configured to process the monocular output received from the single monocular camera to generate a spatial output providing at least two-dimensional information about the physical environment of the spatial output device relative to a location of the spatial output device, the one or more onboard processors being further configured to generate map data from the spatial output, the map data providing information about the location of the spatial output device relative to physical features in the physical environment of the spatial output device, the monocular output processing, the spatial output generation, and the map data generation being performed concurrently by the one or more onboard processors of the spatial output device and independent of output from any other camera.

2. The spatial output device of claim 1, wherein the one or more onboard processors are further configured to transmit the spatial output to a remote computing location.

3. The spatial output device of claim 1, wherein the support from which the flexible electronics connector hangs includes a neck of a user of the spatial output device, the spatial output device further including at least one biometric input sensor, the at least one biometric input sensor being configured to determine an identity of the user.

4. The spatial output device of claim 1, further comprising:
one or more processor-readable storage media devices, wherein the one or more onboard processors are further configured to integrate the map data into a digital map representation stored in the one or more processor-readable storage media devices.

5. The spatial output device of claim 4, wherein the one or more onboard processors are further configured to output directional information directed to a location on the digital map representation through one or more spatial output components.

6. The spatial output device of claim 5, wherein the one or more spatial output components includes one of a speaker and headphones.

7. The spatial output device of claim 5, wherein the one or more spatial output components include a haptic motor.

8. The spatial output device of claim 1, further comprising:
an internal measurement unit (IMU), the IMU being configured to provide acceleration data and orientation data to the one or more onboard processors.

9. The spatial output device of claim 8, wherein the spatial output is generated using the acceleration data and the orientation data provided by the IMU.

10. A spatial sensing and processing method comprising:
electrically connecting two electronics enclosures by a flexible electronic connector, the two electronics enclosures hanging from the flexible electronic connector, the flexible electronic connector being configured to slidably hang from a support, each of the two hanging electronics enclosures being weighted relative to the other electronics enclosure to maintain a balanced position hanging from the flexible electronic connector and the support;
affixing at least one power source to at least one of the two hanging electronics enclosures;
connecting a single monocular camera to the at least one power source, the single monocular camera being affixed to at least one of the two hanging electronics enclosures and producing a monocular output of physical features in a physical environment of a spatial output device; and
connecting an onboard processor to the at least one power source, the onboard processor being affixed to at least one of the two hanging electronics enclosures, the onboard processor being configured to process the monocular output received from the single monocular camera to generate a spatial output providing at least two-dimensional information about the physical environment of the spatial output device relative to a location of the spatial output device, the onboard processor being further configured to generate map data from the spatial output, the map data providing information about the location of the spatial output device, the monocular output processing, the spatial output generation, and the map data generation being performed concurrently by the onboard processor of the spatial output device and independent of output from any other camera.

11. The method of claim 10, wherein the spatial output is output to a remote computing location.

12. The method of claim 10, wherein the onboard processor is further configured to integrate the map data with a map.

13. The method of claim 12, wherein the onboard processor is further configured to provide directions to a location on the map through a pair of spatial output mechanisms located on each of the two electronics enclosures.

14. The method of claim 13, wherein the pair of spatial output mechanisms are one of speakers and headphones.

15. The method of claim 13, wherein the pair of spatial output mechanisms are haptic motors.

16. The method of claim 10, further comprising:
connecting an internal measurement unit (IMU) to the at least one power source, the IMU being configured to provide acceleration data and orientation data to the onboard processor.

17. The method of claim 16, wherein the spatial output is generated using the acceleration data and the orientation data provided by the IMU.

18. A spatial output device comprising:
a flexible electronic connector configured to slidably hang from a support;
two hanging electronics enclosures electrically connected by the flexible electronic connector, each electronics enclosure being weighted relative to the other electronics enclosure to maintain a balanced position hanging from the flexible electronic connector;
at least one power source affixed to at least one of the two hanging electronics enclosures; and
a single monocular camera affixed to at least one of the two hanging electronics enclosures and powered by the at least one power source, the single monocular camera being configured to produce a monocular output of physical features in a physical environment of the spatial output device; and
one or more onboard processors affixed to at least one of the two hanging electronics enclosures and powered by the at least one power source, the one or more onboard processors being configured to process the monocular output received from the single monocular camera to generate a spatial output providing at least two-dimensional information about the physical environment of the spatial output device relative to a location of the spatial output device, wherein the monocular output processing and the spatial output generation are performed independent of output from any other camera.

19. The spatial output device of claim 18, wherein the one or more onboard processors are further configured to generate map data from the spatial output, the map data providing information about the location of the spatial output device relative to the physical features in the physical environment of the spatial output device, the monocular output processing, the spatial output generation, and the map data generation being performed concurrently by the one or more onboard processors of the spatial output device.

20. The spatial output device of claim 19, further comprising: one or more processor-readable storage media devices, wherein the one or more onboard processors are further configured to integrate the spatial output into a digital map representation stored in the one or more processor-readable storage media devices.
